(19) United States
(12) Patent Application Publication
(10) Pub. No.: US 2010/0229733 A1
(43) Pub. Date: Sep. 16, 2010

(54) Multi Level Cooking Device

(76) Inventor: Stephen Huber Castillo, Atlanta, GA (US)

Correspondence Address: Stephen Castillo, 253 S Colonial Homes Cir, NW, Atlanta, GA, 30309, US

(21) Appl. No.: 12/405,184

(22) Filed: Mar. 16, 2009

(51) Int. Cl. A47J 37/00

(52) U.S. Cl. 99/448

(57) ABSTRACT

The invention is a multi-level cooking device with removable heating elements. The invention consists of three separate cooking surfaces with the bottom one being the biggest and the next two incrementally smaller. Each surface is non-stick with a slight slant for excess oil to drip off. The invention has three separate knobs for temperature control of each of the three cooking surfaces. The essence of the invention is the ability to remove and add cooking levels 2 and 3. The bottom one is stationary, but a central panel can be added and two more cooking surfaces can be stacked at a slight angle away from the first one to allow proper room for cooking.

### BACKGROUND OF THE INVENTION

It is well-known that restaurants frequently require multiple cooking stations in order to meet the demands of the customers. However, cooking space is often too small in order to accommodate all of the customers' orders and sacrifices must be made in time and equipment. This invention helps to solve this problem by installing multiple levels of cooking surfaces above the base cooking surface, thus enabling two or three or more times the amount of food can be cooked in the same area, thus freeing valuable space in the cooking area. This can be fully utilized in both home and commercial applications

### DETAILED DESCRIPTION OF THE INVENTION

Base:

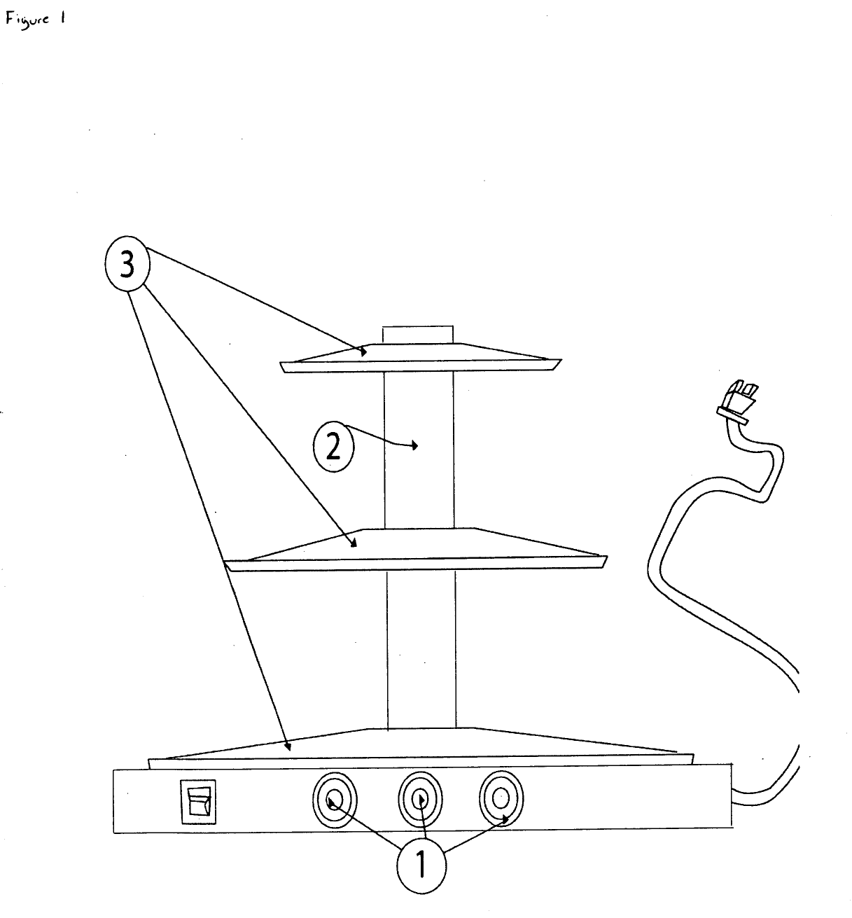

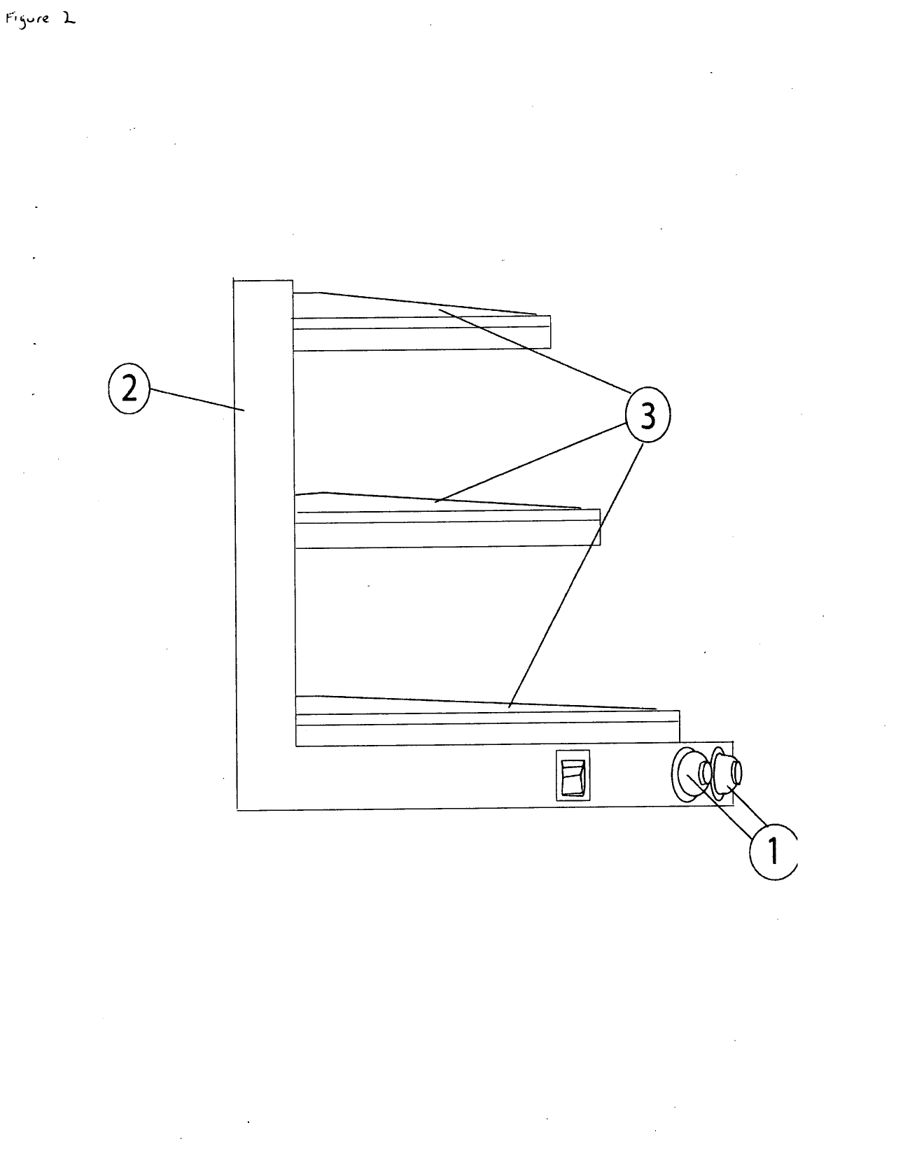

The invention will have a base with three independent knobs with digital timers for each knob allowing a timed cook for each surface (item 3 in FIGS. 1 and 2). This display may be condensed to one singular unit with the ability to toggle between cooking surfaces. Each knob or channel from the display will control one of the three cooking surfaces and allow it to be timed. This means one can have three different times set, one for each cooking surface.

Cooking Surface:

The invention will have three cooking surfaces each attached to a central support unit that will provide each surface with electricity or gas for it to heat the cooking surface with. The bottom panel will be stationary; however, the one or more incrementally smaller panels can be removable depending on what type of cooking experience is required. The cooking surfaces will be non-stick and have the ability to be interchanged; meaning one could attach a larger one for a larger cooking surface or a smaller one for a smaller cooking surface.

Middle Column:

The middle column (item 2 in FIGS. 1 and 2) will serve as the place for the two or more heating surfaces to be attached to. The cooking surfaces will be attached to the central column with a “clip-on” type mechanism where as the weight of the cooking surface will serve as the leverage to keep the surface in place. The column may also have mass sensors to sense if food has been placed on the surface or not. This means that if there is no food on the surface and the control is set to provide heat, the heat will not heat beyond a certain preheating amount. This will prevent any accidents, such as a fire, from occurring in case the device is left on when not intended to be used. The middle column will also serve as the main electrical unit to provide power or gas to the cooking surfaces through wiring or tubing within the column.

Temperature Control:

The invention will be able to simultaneously control multiple temperatures, one for each level as indicated on item 1 of FIGS. 1 and 2. The top two cooking levels will be heated using electrical heating elements with power lines running through the middle support column. The bottom level is also powered electrically. In an alternative embodiment, the bottom level may be temperature controlled by gas in order to rapidly increase the temperature rate and facilitate cooking on that level. The temperatures on the levels can range from ambient to around 350 degrees Fahrenheit in order to ensure that different kinds of foods can be cooked at their ideal temperature.

Safety Section:

The invention will have many safety features including a solid rubber bottom to prevent it from moving. Additionally, the bottom part will be heavier to allow the other cooking surfaces to safely be stacked without it tipping over. Also equipped will be a “food monitoring device” which will automatically shut off the system if no food is on the cooking surface. Also there will be LED lights telling the user when each surface is too hot to touch.

Extra Features:

Along with the base, and the two additional cooking surfaces, there may be included three extra cooking surfaces that can attach upside down on the column to allow for a dual action cooking surface, ie, both sides of what is being cooked will be cooked at once. Also, the invention will be able to be made in three different sizes depending on what type of use it is going to be for example, home use, commercial use, and others. A more advanced feature will be available software that can be used with the device via a USB cable plugged into the device and one can then program specific heating instructions per the food that is being cooked.

Although specific constructions of the invention have been illustrated and described herein, it is not intended that the invention to be limited to the device as disclosed. One skilled in the art will understand that different constructions may be used without departing from the spirit of the invention and the only limitations that apply are in the following claims.

1. A device comprising a base heating element capable of being set to a given temperature within a range of available temperatures, a central column attached to the base and containing electrical wiring or gas pipes, and one additional surface attached to the central column above the base element that receives the gas or electricity from the column and uses it to heat the surface above the base to a specified temperature.

2. A device comprising a base heating element capable of being set to a given temperature within a range of available temperatures, a central column attached to the base and containing electrical wiring or gas pipes, and two or more additional surfaces attached to the central column above the base element that receive the gas or electricity from the column and use it to heat the surface above the base to a specified temperature.

3. The device of claim 1 wherein the one surface above the base is heated by using gas supplied by tubing in the central column.

4. The device of claim 1 wherein the one surface above the base is heated by electrical heating elements using electrical lines from the central column.

5. The device of claim 1 wherein the central column contains weight sensors that determine whether or not there is food on the surfaces and, if there is not, does not increase the temperature beyond a specified safe temperature.

6. The device of claim 1 wherein the surface of the base and the additional surface above it are non-stick to prevent food heated on the surfaces from sticking.

7. The device of claim 1 wherein computer software with programmed settings controls the temperature of each level via a USB port.

8. The device of claim 2 wherein the surfaces above the base are heated by using gas supplied by tubing in the central column.

9. The device of claim 2 wherein the surfaces above the base are heated by electrical heating elements using electrical lines from the central column.

10. The device of claim 2 wherein the central column contains weight sensors that determine whether or not there is food on the surfaces and, if there is not, does not increase the temperature beyond a specified safe temperature.

11. The device of claim 2 wherein the surface of the base and all additional surfaces above it are non-stick to prevent food heated on the surfaces from sticking.

12. The device of claim 2 wherein computer software with programmed settings controls the temperature of each level via a USB port.
